(19) United States
(12) Patent Application Publication
(10) Pub. No.: US 2026/0331081 A1
(43) Pub. Date: Oct. 22, 2026

(54) SNARE WIRES ADJUSTMENT DEVICE

(71) Applicant: K.H.S. MUSICAL INSTRUMENT CO., LTD., New Taipei City (TW)

(72) Inventor: CHUN-HSING CHEN, New Taipei City (TW)

(73) Assignee: K.H.S. MUSICAL INSTRUMENT CO., LTD., New Taipei City (TW)

(21) Appl. No.: 19/185,995

(22) Filed: Apr. 22, 2025

(51) Int. Cl. G10D 13/18

(52) U.S. Cl. CPC G10D 13/18

(57) ABSTRACT

A snare wires adjustment device includes a snare mechanism having two suspenders connected to two opposite ends of a snare assembly; and a holding main body, a movable body movably connected to the holding main body, a suspender connection body connected to the movable body and including a suspender hooking section and a contact section, and a snare strainer for driving the movable body to move relative to the holding main body, such that the suspender connection body and the movable body move synchronously. One of the suspenders is extended across the contact section to be hooked to the suspender hooking section, such that the suspender has a part received in a hooking space of the suspender hooking section and another part contacting the contact section. With these arrangements, the snare mechanism can be quickly connected to and removed from the suspender connection body without using any hand tool.

### FIELD OF THE INVENTION

The present invention relates to a snare wires adjustment device for use with a snare drum, and more particularly, to a snare wires adjustment device, with which a user can manually mount a snare mechanism to an adjustment mechanism and quickly dismount the snare mechanism from the adjustment mechanism without using any hand tool.

### BACKGROUND OF THE INVENTION

Snare drum is one of very common percussion instruments used in musical performance. Please refer to FIGS. 1A to 1C. A conventional snare drum 50 mainly includes a drum body 51, a snare mechanism 52, a connection mechanism (not shown), and an adjustment mechanism 53. The drum body 51 consists of a hollow shell 511 and two heads (not shown) connected to a top end and a bottom end of the shell 511. The snare mechanism 52 is located below the shell 511 and includes two spaced snare wire connection plates 521. The two snare wire connection plates 521 together hold a plurality of snare wires 522 thereto such that the snare wires 522 are located between the two snare wire connection plates 521. Each of the two snare wire connection plates 521 has a suspender 523 connected thereto. And, the connection mechanism is provided on the shell 511 and clamped to one of the suspenders 523.

As shown in FIGS. 1B and 1C, the adjustment mechanism 53 includes a holding main body 531, a movable body 532, a snare strainer 533, and a suspender connection body 534. The holding main body 531 for connecting the shell 511 of the drum body 51, and the movable body 532 is assembled to the holding main body 531 and movable along the z-axis, such that the movable body 532 is linearly movable in the direction of the z-axis relative to the holding main body 531. The snare strainer 533 is connected to both the holding main body 531 and the movable body 532. The snare strainer 533 can drive the movable body 532 to move along the z-axis. Further, the suspender connection body 534 is connected to the movable body 532, such that the suspender connection body 534 is movable synchronously with the movable body 532. The suspender connection body 534 includes a suspender connection seat 534a, a connecting plate 534b, and two plate screws 534c. The plate screws 534c are extended through the connecting plate 534b and screwed to the suspender connection seat 534a, such that the suspender connection seat 534a and the connecting plate 534b are clamped to another suspender 523. Therefore, the connection mechanism and the adjustment mechanism 53 are separately connected to two opposite ends of the snare mechanism 52.

However, the suspender connection seat 534a and the connecting plate 534b of the adjustment mechanism 53 must be manually clamped to the suspender 523 of the snare mechanism 52 by a user using a hand tool to connect the pressing screws 534c to the suspender connection seat 534a and the connecting plate 534b. On the other hand, to separate the snare mechanism 52 from the adjustment mechanism 53, the user also has to loosen the plate screws 534c using the hand tool, such that the connecting plate 53b can be separated from the suspender connection seat 534a before the suspender 523 can be removed from a position between the suspender connection seat 534a and the connecting plate 534b. That is, no matter when it is desired to mount the snare mechanism 52 to the adjustment mechanism 53 or to separate the snare mechanism 52 from the adjustment mechanism 53, procedures needed to do so all are relied on a hand tool. This condition no doubt not only increases the operational steps of mounting and separating the snare mechanism, but also increases the complexity and time in doing so and brings a certain degree of inconvenience to the user.

Further, each time the snare mechanism 52 is mounted to the adjustment mechanism 53, since the suspender connection seat 534a and the connecting plate 534b of the adjustment mechanism 53 are not always exactly clamped to the same position on the suspender 523, the snare wires 522 of the snare mechanism 52 might be set to different tension states, which would have an influence on the sound quality produced by the snare drum 50 when it is battered. Specifically, in the case the suspender connection seat 534a and the connecting plate 534b are clamped to the suspender 523 at a position closer to the snare connection plate 521 of the snare mechanism 52, the snare wires 522 would be excessively tensioned and the snare drum 50 being battered would produce excessively high-pitched sound. On the other hand, in the case the suspender connection seat 534a and the connecting plate 534b are clamped to the suspender 523 at a position far away from the snare connection plate 521 of the snare mechanism 52, the snare wires 522 would be excessively loose and the snare drum 50 being battered would produce a deep and muffled sound. Since the suspender connection seat 534a and the connecting plate 534b clamped to incorrect position on the suspender 523 would prevent the snare drum 50 from producing a desired sound, the user has to repeatedly remount the snare mechanism 52 on the adjustment mechanism 53. The repeated mounting and adjustment not only increases the complexity in operation, but also largely increases the time cost.

### SUMMARY OF THE INVENTION

A primary object of the present invention is to provide a suspender connection body with an improved structural configuration, such that a snare mechanism and the improved suspender connection body for be connecting or disconnected from each other without using any hand tool, and procedures of connecting and disconnecting the snare mechanism to and from the improved suspender connection body can be effectively simplified to enable quick disconnection of the snare mechanism from the improved suspender connection body with bare hands. Further, each time the snare mechanism is mounted on the improved suspender connection body, snare wires of the snare mechanism can always be maintained in a proper range of tensions for a snare drum using the improved suspender connection body and snare mechanism of the present invention to produce ideal sounds when being played with drumsticks and accordingly, to effectively avoid any deviated snare drum timbre due to excessive tension or excessive looseness of the snare wires.

Another object of the present invention is to provide a snare strainer with an improved structural configuration, such that the improved snare strainer allows a movable body of the adjustment mechanism is stopped in multiple steps by the snare strainer., such that the snare wires of the snare mechanism can be attached to a snare head of the snare drum in various degrees and accordingly, gives the snare drum timbre an effectively expanded range of changes and increased diversity of drum performance.

A further object of the present invention is to provide a snare adjustment mechanism with an improved structural configuration to reduce a frictional force between a snare strainer and a movable body of the adjustment mechanism, such that the snare strainer can drive the movable body to move smoothly and accordingly reduce the risk of failed interaction between the snare strainer and the movable body.

A still further object of the present invention is to provide a suspender connection body with an improved structural configuration, such that the improved suspender connection body can be used with suspenders in the form of cords or strips, allowing the suspender connection body to be freely used with different forms of suspenders. A snare mechanism, no matter having cord-shaped suspenders or strip-shaped suspenders, can be connected to the improved suspender connection body.

A still further object of the present invention is to provide improved coordination between a snare strainer and a movable body of an adjustment mechanism for snare drum, so as to ensure the movable body can be driven by the snare strainer to move every time and accordingly ensure that the snare strainer can always in effect contact with the movable body in the process of adjusting the degree to which the snare wires of the snare mechanism are attached to the snare head of the snare drum and to effectively avoid the snare strainer from being stuck to the movable body and failing to drive the movable body to move.

To achieve the above and other objects, a snare wires adjustment device is provided according to the present invention and includes a snare mechanism and an adjustment mechanism.

The snare mechanism includes a snare assembly and two suspenders connected to the snare assembly. The adjustment mechanism includes a holding main body, a movable body, a suspender connection body, and a snare strainer. The holding main body is connected to a shell of a snare drum. The movable body is movably connected to the holding main body, such that the movable body is movable relative to the holding main body. The suspender connection body is movable synchronously with the movable body and includes a suspender hooking section and a contact section; and the suspender hooking section defines a hooking space. The snare strainer can drive the movable body to move.

One of the suspenders can be extended from the snare assembly across the contact section to be hooked to the suspender hooking section, such that a part of the suspender is received in the hooking space while another part of the suspender is in contact with the contact section.

In the above embodiment, the suspender connection body includes a suspender connection seat and a suspender connection pillar. The suspender connection seat is partially sunken to form two connection recesses for receiving a part of the suspender, such that the part of the suspender received in the connection recesses contacts surfaces of the connection recesses and the connection recesses form the contact section. The suspender connection pillar includes a connection neck section located closer to the suspender connection seat and a connection head section located far away from the suspender connection seat. The hooking space is formed between the connection neck section and the connection head section and the suspender hooking section is formed at the suspender connection pillar.

The suspender connection pillar is located between the two connection recesses, and the suspender connection pillar has an uppermost point below the connection recesses. The suspender connection body further includes a connecting plate, a set of plate screws, and a suspender connector. Each of the plate screws includes a shank portion and a hread portion, the shank portion protrudes the connecting plate for fixing on the suspender connection seat, such that the connecting plate is clamped between the head portion and the suspender connection seat. One side of the connecting plate adjacent to the suspender connection seat is sunken to form an accommodating space. The suspender connector includes a connection head portion received in the accommodating space and a connection rod portion formed at an end of the connection head portion. The connection rod portion is located outside the accommodating space and connected to the connection neck section of the suspender connection pillar.

Further, the suspender connection seat has a first connecting surface in contact with the connecting plate and a second connecting surface having the connection recesses formed thereon. The connection recesses include a first turning corner located adjacent to the first connecting surface and two recess bottom surfaces located below and spaced from the second connecting surface. When the suspender is located in the hooking space and the connection recesses at the same time, the suspender is in contact with the first turning corner to form a first bending section. The connection recesses further include a second turning corner formed on one side of the connection recesses located opposite to the first turning corner, and the suspender is in contact with the second turning corner to form a second bending section that is spaced from the first bending section.

The movable body includes a movable rod extended through the holding main body and a linkage rod intersecting with the movable rod. The snare strainer includes a snare strainer rail recessed from one side of the snare strainer, and the linkage rod is extended into the snare strainer rail. The snare strainer is pivotally for connecting the holding main body to be turnable about a rotation axis relative to the holding main body. The snare strainer rail has a rail proximal end located closer to the rotation axis and a rail distal end located far away from the rotation axis. The snare strainer rail is extended from the rail proximal end toward the rail distal end to form a rail wall surface contactable with the linkage rod. Whereby when the snare strainer is rotated relative to the holding main body, the linkage rod can be alternatively moved along the rail wall surface to one of the rail proximal end and the rail distal end to be located closer to or far away from the rotation axis, respectively, and allow the movable rod to move relative to the holding main body.

The snare strainer is provided with a snare strainer pivot hole located adjacent to the rail proximal end and communicable with the snare strainer rail. The holding main body includes a pivot stem that is extended into the snare strainer pivot hole and provided at a lower side with a pivot stem groove. When the snare strainer is rotated and the linkage rod is moved toward the rail proximal end of the snare strainer rail, the linkage rod will move into the pivot stem groove; and when the snare strainer is rotated and the linkage rod is moved toward the distal end of the snare strainer rail, the linkage rod will move out of the pivot stem groove. The snare strainer rail further includes a rail recess provided between the rail proximal end and the rail distal end for receiving a part of the linkage rod therein, such that the linkage rod can temporarily stop moving in the snare strainer rail.

The adjustment mechanism further includes a return spring, which is provided and elastically deformable between the holding main body and the movable body and is elastically deformed to exert a return force on the movable body, such that the linkage rod of the movable body is kept contacting the rail wall surface under the return force.

The adjustment mechanism further includes an adjustment body. The adjustment body is extendable through the linkage rod and the movable rod to screw withthe suspender connection body, such that the suspender connection body is alternatively movable closer to or far away from the movable body when the adjustment body is rotated relative to the movable body.

The linkage rod includes a linkage member for connecting the movable rod and a roller made of a non-metal material. The roller is mounted to an end of the linkage member and is in contact with the rail wall surface to reduce a frictional force between the linkage rod and the snare strainer rail.

The present invention is characterized in that the suspender connection body of the adjustment mechanism is provided with a suspender hooking section and a contact section. One of the suspenders of the snare mechanism can be extended from the snare assembly across the contact section to be hooked to the suspender hooking section, such that a part of the suspender is received in the hooking space while another part of the suspender is in contact with the contact section. With these arrangements, the snare mechanism and the suspender connection body can be connected to or disconnected from each other without any hand tool, such that procedures for the connection and disconnection between the snare mechanism and the suspender connection body can be effectively simplified and a user can quickly disconnect the snare mechanism from the suspender connection body with bare hands. Further, each time the suspender of the snare mechanism is hooked to the suspender hooking section, the snare wires can be maintained at a proper range of tensions for the snare drum to produce ideal sounds when the snare drum is played with drumsticks and accordingly, effectively avoid from spoiling the sound quality of the snare drum due to excessive tension or excessive looseness of the snare wires.

Since the snare strainer is pivotally for connecting the holding main body and the snare strainer is formed with a snare strainer rail for the linkage rod of the movable body to extend thereinto, the snare strainer can be rotated relative to the snare strainer and drive the movable body to move along the rail wall surface of the snare strainer rail. Further, the snare strainer rail includes a rail recess formed between the rail proximal end and the rail distal end. When the linkage rod is aligned with the rail recess, the linkage rod .is partially received in the rail recess and accordingly, temporarily stops moving in the snare strainer rail. With this mechanism, the snare strainer can drive the movable body is stopped in multiple steps by the snare strainer., such that the degree to which the snare wires of the snare mechanism are attached to the snare head of the snare drum is changeable to not only effectively expand the range of timbre of the snare drum, but also increase the diversity of drum performance.

Further, the roller of the linkage rod is made of a non-metal material, such that the roller can contact the rail wall surface of the snare strainer rail with a significantly reduced frictional force between the linkage rod and the snare strainer rail, and the snare strainer can drive the movable body to move smoothly to reduce the risk of failed interaction between the snare strainer and the movable body.

The suspender connection body mainly includes a suspender hooking seat, a suspender connection pillar, a connecting plate, a set of plate screws, and a suspender connector. The plate screws are extended through the connecting plate to connect to the suspender connection seat, such that the strip-like suspender is clamped between the connecting plate and the suspender connection seat, and the suspender connection pillar is connected to the suspender connector that is clamped between the connecting plate and the suspender connection seat. Therefore, the suspender connection pillar formed the suspender hooking section for the suspender to hook thereto. With these arrangements, the suspender connection body can be adapted to both a cord-like suspender and a strip-like suspender, allowing the suspender connection body to be freely used with different types of suspenders.

Further, the adjustment mechanism includes a return spring disposed between the holding main body and the movable body. The return spring pushes against the movable body for the linkage rod to continuously contact the rail wall surface of the snare strainer rail, such that the snare strainer can always in effect contact with the movable body in the process of driving the movable body to move and adjusting the degree to which the snare wires of the snare mechanism are attached to the snare head of the snare drum. With these arrangements, it is able to effectively avoid the snare strainer from being stuck to the movable body and failing to drive the movable body to move.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1A is a bottom perspective view of a conventional snare drum;

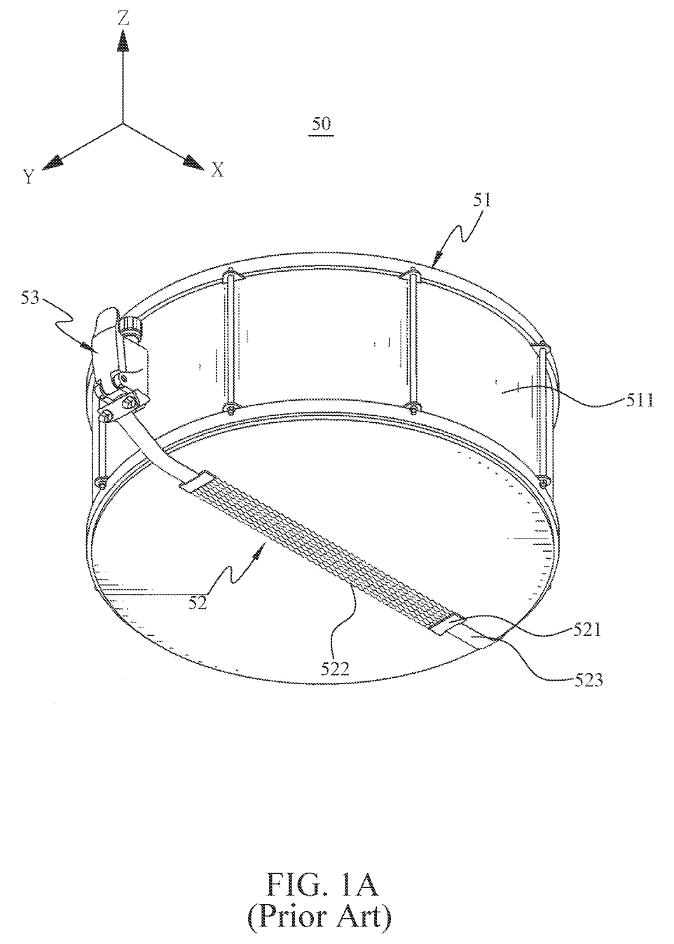

FIG. 1B is a perspective view of an adjustment mechanism and a snare strainer of the conventional snare drum of FIG. 1A in an assembled state;

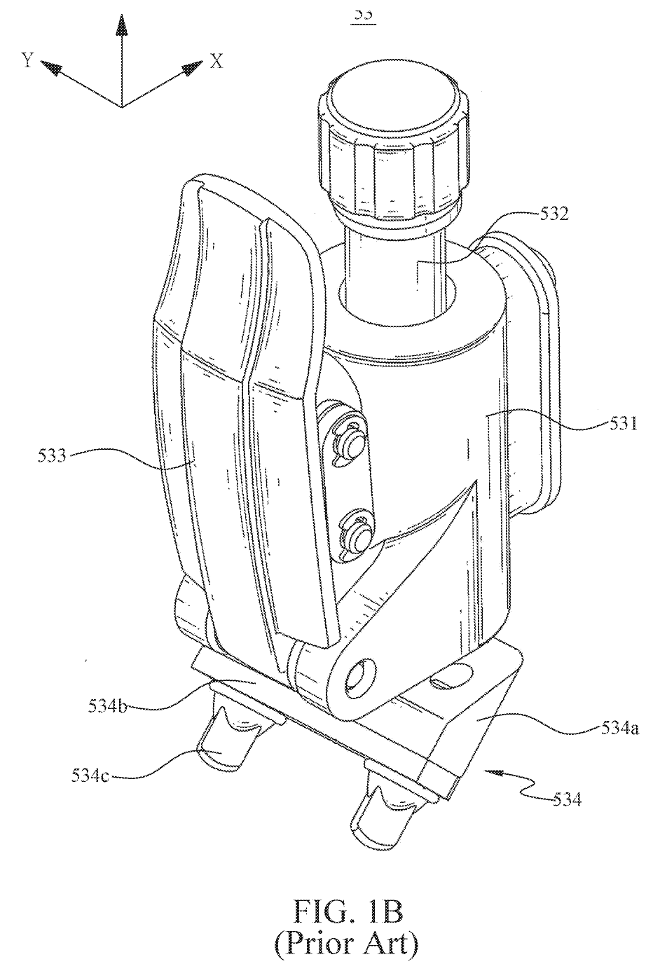

FIG. 1C is a sectional side view of FIG. 1B;

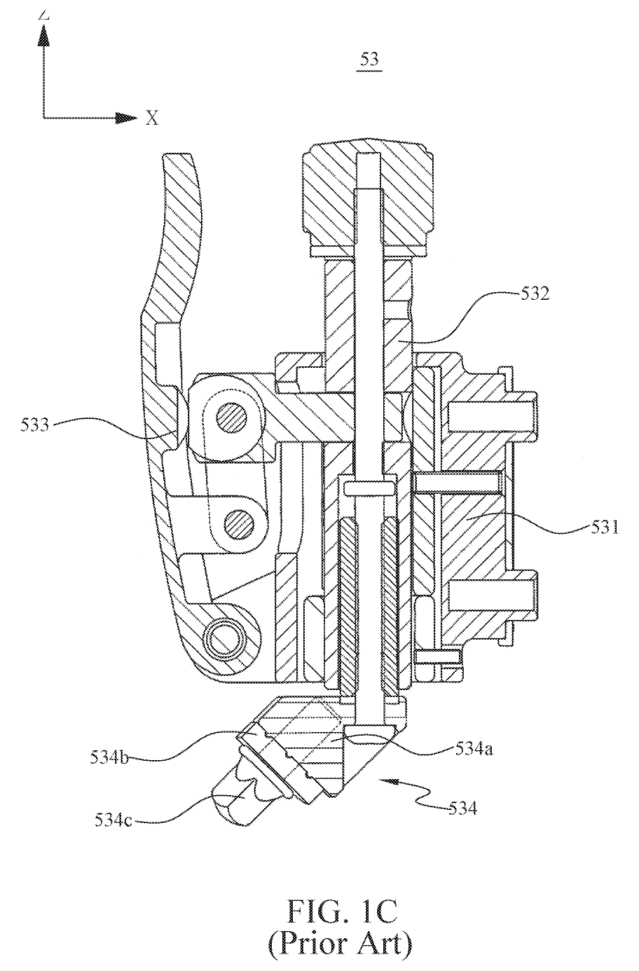

FIG. 2 is a bottom perspective view of a snare drum provided with a snare wires adjustment device according to an embodiment of the present invention;

FIG. 3 is an exploded view of FIG. 2;

FIG. 4 is a fragmentary view showing a connection mechanism according to the present invention is connected to a shell of the snare drum of FIG. 2;

FIG. 5 is a fragmentary view showing an adjustment mechanism according to the present invention is connected to the shell of the snare drum of FIG. 2;

FIG. 6 is an exploded perspective view of the adjustment mechanism of FIG. 5;

FIG. 7 is a sectional side view of FIG. 6;

FIG. 8 is an assembled view of FIG. 7;

FIG. 9 is an exploded sectional side view of a suspender connection body according to the present invention as shown in FIG. 7;

FIG. 10 is an assembled side view showing the suspender connection body of FIG. 7 has a right suspender connected thereto;

FIG. 11 is a front view of a snare strainer tuning plate of the adjustment mechanism according to the present invention;

FIG. 12A shows a roller of the adjustment mechanism according to the present invention is located closer to a rail distal end defined on the snare strainer tuning plate of FIG. 11;

FIG. 12B shows a plurality of snare wires is in minimal contact with a snare head of the snare drum according to the present invention;

FIG. 12C shows the roller of the adjustment mechanism according to the present invention is located in a rail recess defined on the snare strainer tuning plate of FIG. 11;

FIG. 12D shows the plurality of snare wires is brought to be in closer contact with the snare head of the snare drum according to the present invention;

FIG. 12E shows the roller of the adjustment mechanism according to the present invention is located closer to a rail proximal end defined on the snare strainer tuning plate of FIG. 11;

FIG. 12F shows the snare wires are in maximum contact with the snare head of the snare drum according to the present invention;

FIG. 12G shows the roller is moving toward the rail proximal end defined on the snare strainer tuning plate of FIG. 11; and

FIG. 12H shows the snare wires are brought to be in less contact with the snare head of the snare drum according to the present invention.

The present invention will now be described with a preferred embodiment thereof and by referring to the accompanying drawings. For the purpose of easy to understand, elements that are the same in the preferred embodiment are denoted by the same reference numerals.

In the accompanying drawings, two opposite ends of the x-axis indicate a left and a right side of a drummer who plays a snare drum 40; two opposite ends of the y-axis indicate a front and a rear side of the drummer who plays the snare drum 40; and two opposite ends of the z-axis indicate an upper and a lower side of the drummer who plays the snare drum 40. Further, the directional terms “front”, “rear”, “left”, “right”, “upper”, and “lower” used in the present specification corresponding to the directions in which the drummer faces when he plays the snare drum 40.

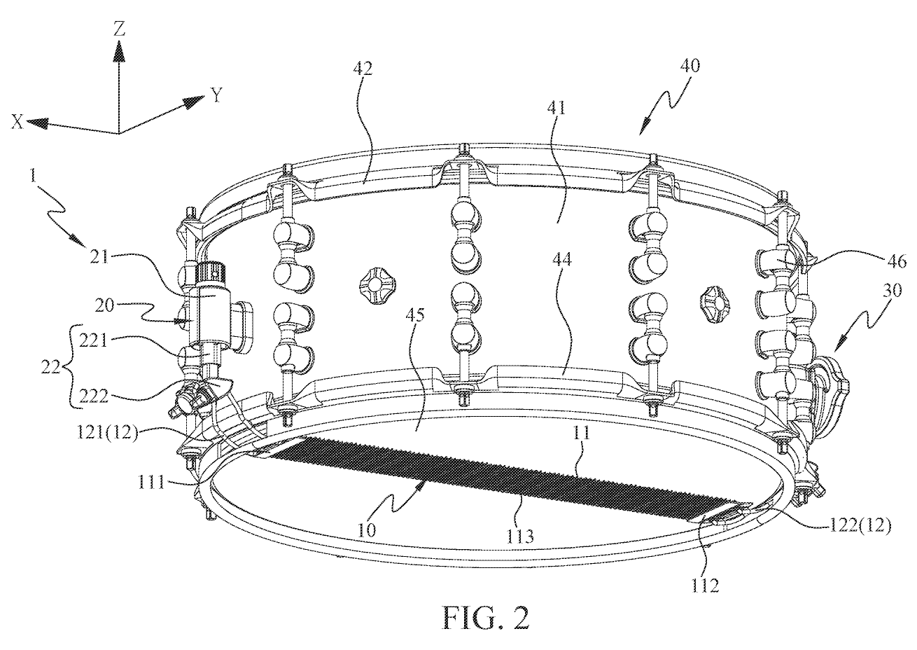

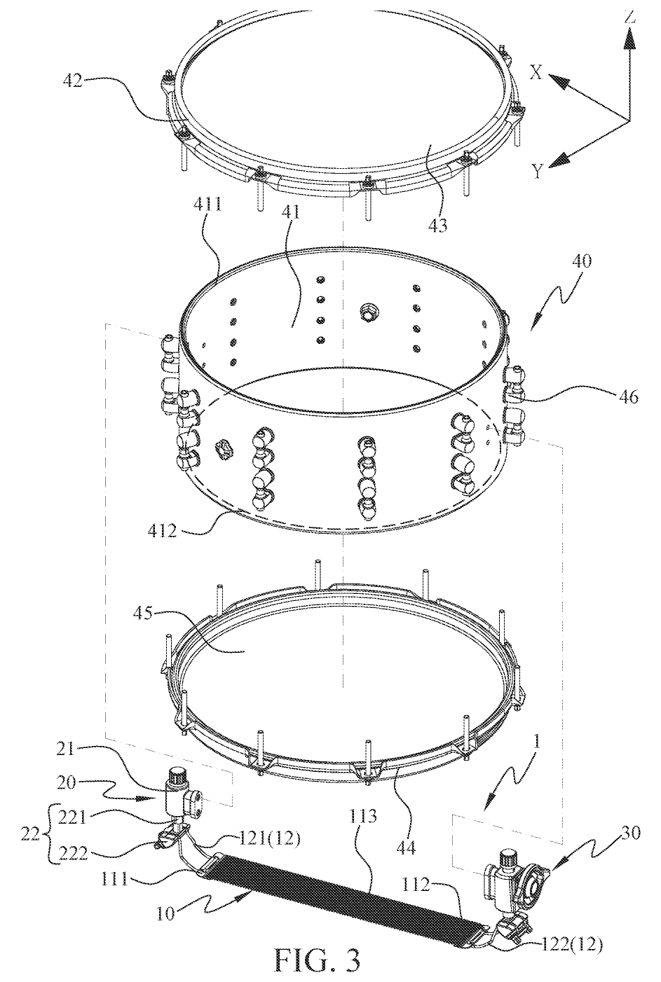

Please refer to FIGS. 2 and 3. The present invention relates to a snare wires adjustment device 1 for a snare drum 40. The snare wires adjustment device 1 includes a snare mechanism 10, a connection mechanism 20, and an adjustment mechanism 30. As shown, the snare drum 40 includes a hollow barrel-shaped shell 41, which has an upper and a lower end forming spaced upper opening 411 and lower opening 412, respectively. Both the upper and lower openings 411, 412 are communicable with an internal space defined in the shell 41. The shell 41 further includes a top hoop 42 fitted on around the upper opening 411 to firmly hold a batter head 43 over the upper opening 411, and a bottom hoop 44 fitted on around the lower opening 412 to firmly hold a snare head 45 over the lower opening 412. The snare drum 40 further includes a plurality of tension lugs 46 provided around an outer side of the shell 41 between the top and the bottom hoop 42, 44 for adjusting the tension on the top and the bottom head 43, 45.

As can be seen in FIGS. 2 and 3, the snare mechanism 10 is provided below of the snare head 45 of the snare drum 40 and includes a snare assembly 11 and two suspenders 12. The snare assembly 11 includes a left snare wire connection plate 111 and a right snare wire connection plate 112 located at and spaced from a right side of the left snare wire connection plate 111. The left snare wire connection plate 111 is located in the vicinity of a left side of the shell 41 of the snare drum 40, and the right snare wire connection plate 112 is located in the vicinity of a right side of the shell 41. The left and the right snare wire connection plate 111, 112 have a plurality of snare wires 113 connected to between them. As shown, the two suspenders 12 are respectively in the form of a cord-like suspender. One of the two suspenders 12 is for connecting the left snare wire connection plate 111 and is herein defined as a left suspender 121, while the other suspender 12 is for connecting the right snare wire connection plate 112 and is herein defined as a right suspender 122.

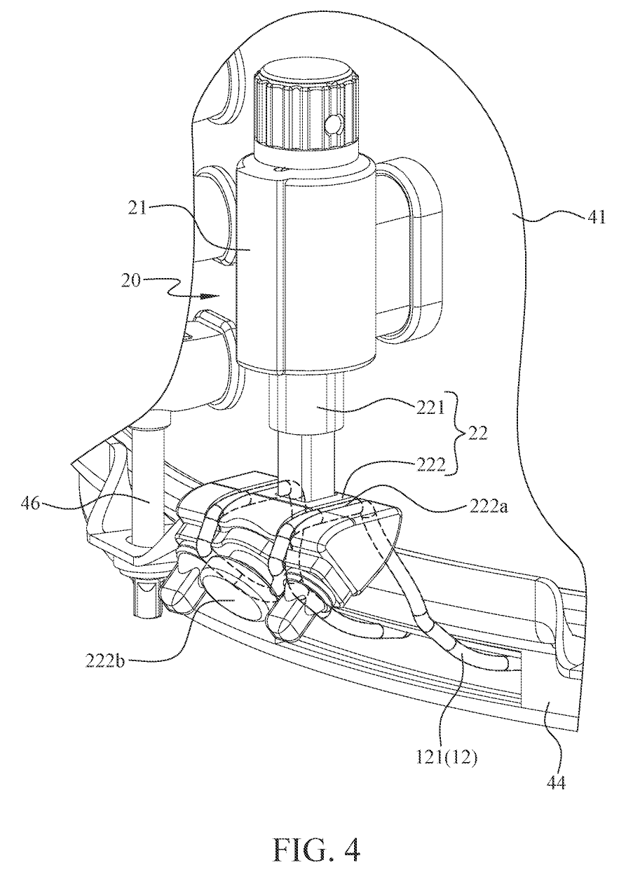

Please refer to FIGS. 3 and 4. The connection mechanism 20 is provided on an outer side of the shell 41 of the snare drum 40 to be located at the left side of the shell 11. The connection mechanism 20 includes two parts, one of which is a fixed support 21 connected to the shell 41, and the other one of which is a movable support 22 assembled to the fixed support 21 and movable in the z-axis direction. The movable support 22 includes a movable rod 221 extended into the fixed support 21 and a movable base 222 located outside the fixed support 21. The movable rod 221 is connected at a lower end to the movable base 222, such that the movable base 222 is located below the fixed support 21. One side of the movable base 222 facing toward the fixed support 21 is formed with two movable base slots 222a; and another side of the movable base 222 facing away from the shell 41 is formed with a movable base hooking section 222b. Therefore, the two movable base slots 222a and the movable base hooking section 222b are sequentially formed on the movable base 222 in a direction opposite to the shell 41. In the illustrated embodiment, the left suspender 121 of the snare mechanism 10 starts from the left snare wire connection plate 111 and extends into the movable base slots 222a to be hooked to the movable base hooking section 222b, such that a part of the left suspender 121 is embedded in the movable base hooking section 222b. Meanwhile, another part of the left suspender 121 can be located in the movable base slots 222a to contact surfaces of the movable base slots 222a.

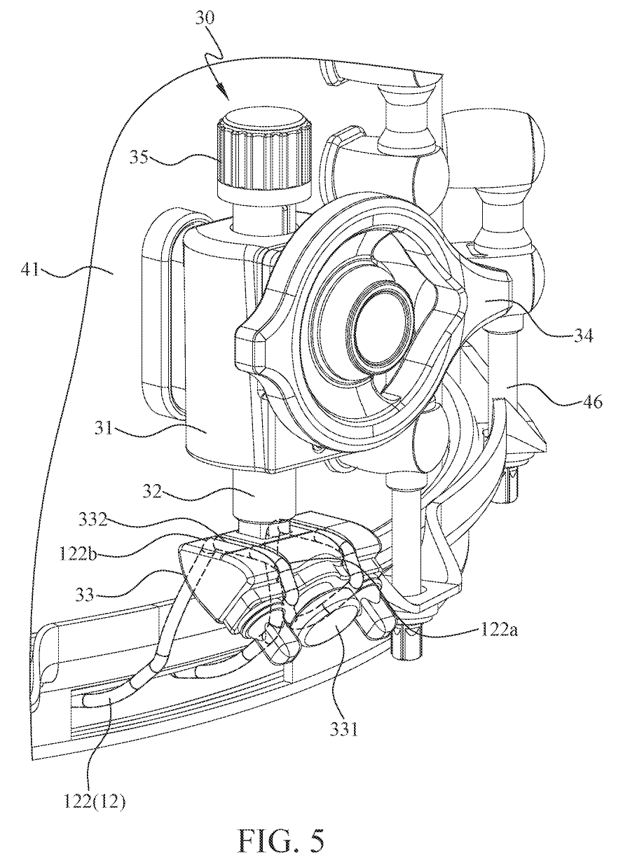

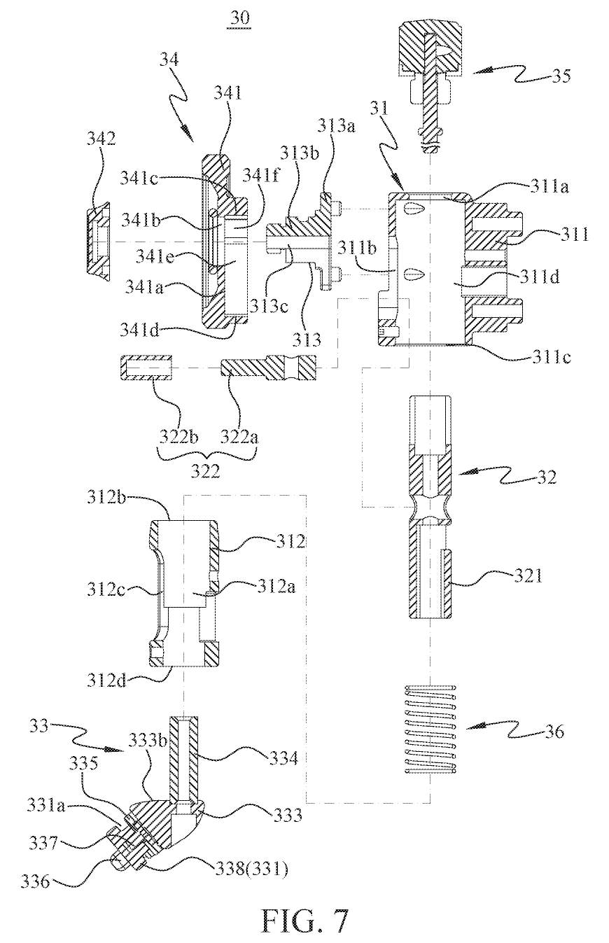

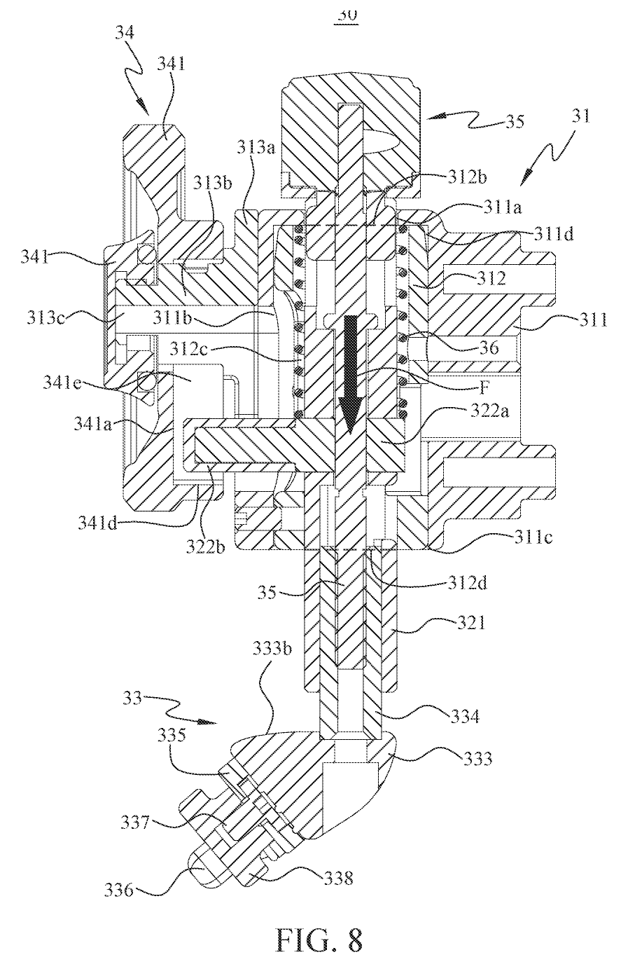

Please refer to FIGS. 3 and 5 to 8. The adjustment mechanism 30 is located at a right outer side of the shell 41 of the snare drum 40 and mainly includes a holding main body 31, a movable body 32, a suspender connection body 33, a snare strainer 34, an adjustment body 35, and a return spring 36. In the illustrated embodiment, the holding main body 31 includes a fixed holding seat 311, a bearing sleeve 312, and a pivotal member 313. The fixed holding seat 311 is for connecting the shell 41 and is formed at an upper, a right, and a lower side with an upper fixed opening 311a, a right fixed narrow slot 311b, and a lower fixed opening 311c, respectively. The upper fixed opening 311a, the right fixed narrow slot 311b, and the lower fixed opening 311c all are communicable with a fixed space 311d in the fixed holding seat 311. Further, the bearing sleeve 312 is a hollow member to internally define a bearing space 312a, which communicates with an upper bearing opening 312b located at an upper end of the bearing sleeve 312, a right bearing narrow slot 312c located at a right side of the bearing sleeve 312, and a lower bearing opening 312d located at a lower end of the bearing sleeve 312. The bearing sleeve 312 is disposed in the fixed space 311d with the upper bearing opening 312b located corresponding to a lower side of the upper fixed opening 311a, the right bearing narrow slot 312c located corresponding to a left side of the right fixed narrow slot 311b, and the lower bearing opening 312d located corresponding to an inner side of the lower fixed opening 311c. As shown in the drawings, the pivotal member 313 includes a pivot plate 313a for connecting a right side of the fixed holding seat 311 and a pivot stem 313b extended from the pivot plate 313a and located above the right fixed narrow slot 311b. Further, the pivot stem 313b is provided at a lower side with a pivot stem groove 313c.

The movable body 32 of the adjustment mechanism 30 includes a movable rod 321 extending in parallel with the z-axis and a linkage rod 322 extending in parallel with the x-axis. The linkage rod 322 includes a linkage member 322a connected to and accordingly, intersecting with a central area of the movable rod 321. An end of the linkage member 322a far away from the movable rod 321 has a non-metal roller 322b mounted thereto. The movable body 32 is movably along the z-axis to be movably assembled and connected to the holding main body 31 of the adjustment mechanism 30, such that the movable body 32 is movable in the direction of the z-axis relative to the holding main body 31. In the illustrated embodiment, when the movable body 32 is movably connected to the holding main body 31, the movable rod 321 is extended through an interior of the bearing space 312a, such that an upper and a lower end of the movable rod 321 are exposed from the upper and the lower bearing opening 312b, 312d, respectively, of the bearing sleeve 312 and located outside the fixed space 311d of the fixed holding seat 311. Meanwhile, the linkage member 322a is extended through the right fixed narrow slot 311b of the fixed holding seat 311, such that a part of the linkage member 322a and the whole roller 322b are located outside the fixed space 311d.

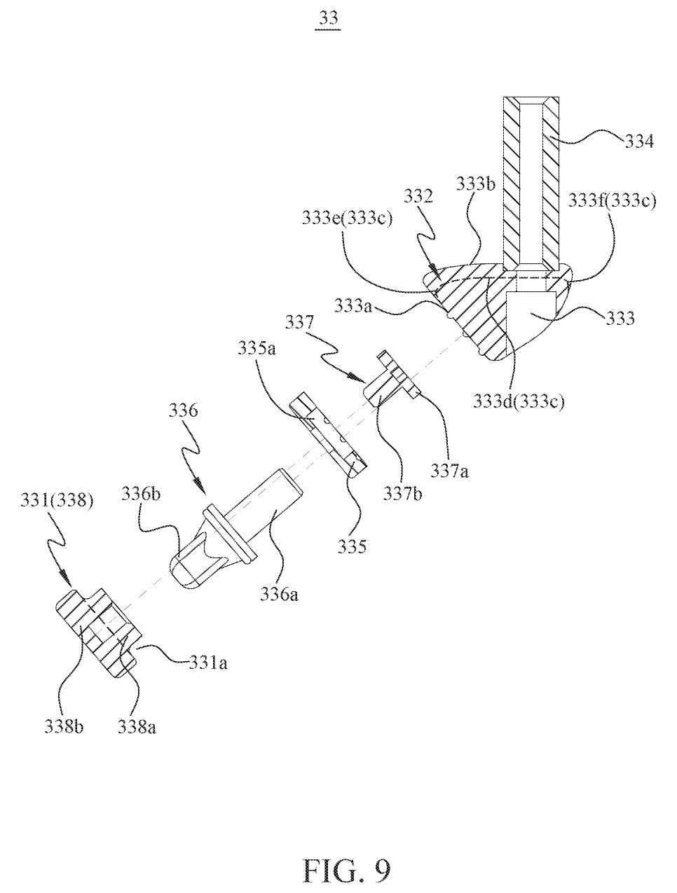

Please refer to FIGS. 3 and 5 to 9. The suspender connection body 33 of the adjustment mechanism 30 is connected to a lower end of the movable rod 321 of the movable body 32, such that the suspender connection body 33 is movable along the z-axis outside the fixed space 311d of the fixed holding seat 311 synchronously with the movable body 32 of the adjustment mechanism 30. Further, the suspender connection body 33 is provided at different positions with a suspender hooking section 331 and a contact section 332; and the suspender hooking section 331 defines a hooking space 331a. The right suspender 122 of the snare mechanism 10 can be extended from the snare assembly 11 of the snare mechanism 10 across the contact section 332 to be hooked to the suspender hooking section 331, such that a part of the right suspender 122 is embedded in the hooking space 331a while the other part of the right suspender 122 is in contact with the contact section 332. In the illustrated embodiment, the suspender connection body 33 includes a suspender connection seat 333, a connection guide post 334, a connecting plate 335, a set of plate screws 336, a suspender connector 337, and a suspender connection pillar 338. The suspender connection seat 333 is located below the fixed holding seat 311 and sequentially includes, from a rightmost side thereof, a first connecting surface 333a and a first turning corner 333e located at a right side of the suspender connection seat 333, a second connecting surface 333b and a second turning corner 333f located at an upper side of the suspender connection seat 333. In the illustrated embodiment, the first connecting surface 333a is a slant surface and the second connecting surface 333b is a horizontal surface. As shown, the suspender connection seat 333 is partially sunken to form two spaced front and rear connection recesses 333c, which are extended from the first turning corner 333e through the second connecting surface 333b to the second turning corner 333f. The connection recesses 333c respectively have a recess bottom surface 333d, which is located below and spaced from the second connecting surface 333b. One side of the recess bottom surfaces 333d of the connection recesses 333c located adjacent to the first connecting surface 333a is the first turning corner 333e, and another side of the bottom surfaces 333d of the connection recesses 333c opposite to the first turning corner 333e is the second turning corner 333f. The connection guide post 334 is connected to the second connecting surface 333b of the suspender connection seat 333, and the connection guide post 334 is located between the two connection recesses 333c. Further, the connection guide post 334 can be extended into the movable rod 321 of the movable body 32.

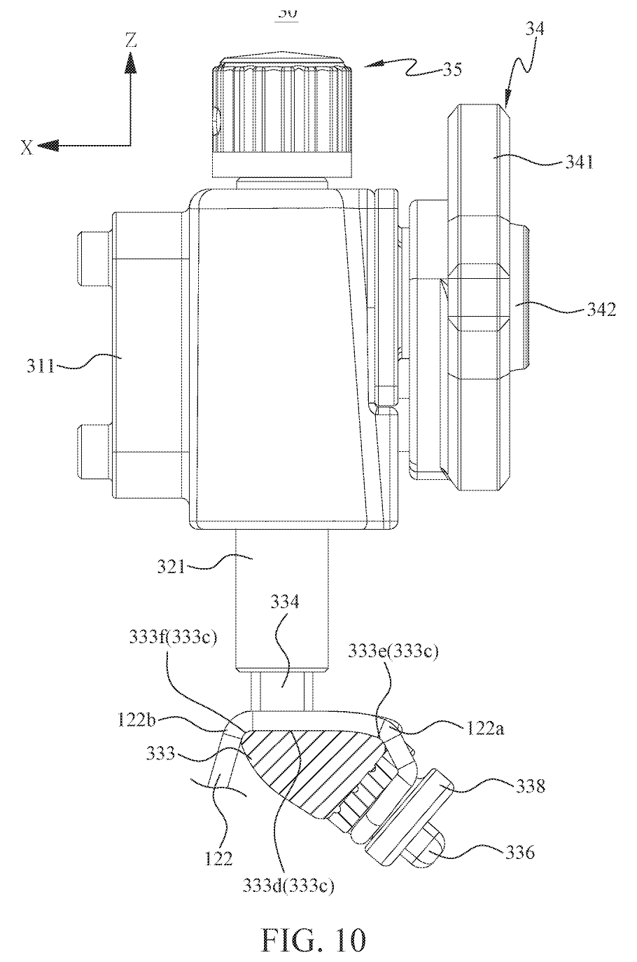

Please refer to FIGS. 3 and 5 to 8. The connecting plate 335 of the suspender connection body 33 is in contact with the first connecting surface 333a of the suspender connection seat 333. One side of the connecting plate 335 adjacent to the suspender connection seat 333 is sunken to form an accommodating space 335a between the two connection recesses 333c. Each of the plate screws 336 of the suspender connection body 33 includes a screw shank portion 336a and a thread portion 336b having a profile larger than that of the screw shank portion 336a. The screw shank portion 336a is extended through the connecting plate 335 to screw into the suspender connection seat 333, such that the thread portion 336b is in contact with the connecting plate 335 to thereby clamp the connecting plate 335 between the thread portion 336b and the suspender connection seat 333. Further, the suspender connector 337 includes a connection head portion 337a that is received in the accommodating space 335a and a connection rod portion 337b that has a profile smaller than that of the connection head portion 337a and is extended from the connection head portion 337a to a position outside the accommodating space 335a, such that a part of the connection rod portion 337b is located at an outer side of the accommodating space 335a. The suspender connection pillar 338 has a portion located closer to the suspender connection seat 333 is defined as a connection neck section 338a; and the remaining portion of the suspender connection pillar 338 located far from the suspender connection seat 333 and having a profile larger than that of the connection neck section 338a is defined as a connection head section 338b. The connection neck section 338a is connected to the connection rod portion 337b, such that the suspender connection pillar 338 is located between the two connection recesses 333c of the suspender connection seat 333. Accordingly, a highest point of the suspender connection pillar 338 is located at a height position lower then that of the connection recesses 333c. In the illustrated embodiment, the two connection recesses 333c form the contact section 332 of the suspender connection body 33, and the hooking space 331a of the suspender hooking section 331 is formed between the connection neck section 338a and the connection head section 338b, such that the suspender connection pillar 338 forms the suspender hooking section 331 of the suspender connection body 33. As shown in FIG. 10, when the right suspender 122 of the snare mechanism 10 is extended from the snare assembly 11 of the snare mechanism 10 across the contact section 332 to be hooked to the suspender hooking section 331, a part of the right suspender 122 is located between the connection neck section 338a and the connection head section 338b, and another part of the right suspender 122 is located in the connection recesses 333c and in contact with the surfaces of the connection recesses 333c. Meanwhile, different locations of the right suspender 122 would be in contact with the first and the second turning corner 333e, 333f of the suspender connection seat 333, such that first bending section 122a and a second bending section 122b spaced from each other are formed on the right suspender 122 at the above locations. As can be seen in FIG. 10, the first bending section 122a is in contact with the first turning corner 333e and located adjacent to one side of the connection recesses 333c, while the second bending section 122b is in contact with the second turning corner 333f and located adjacent to the other side of the connection recesses 333c.

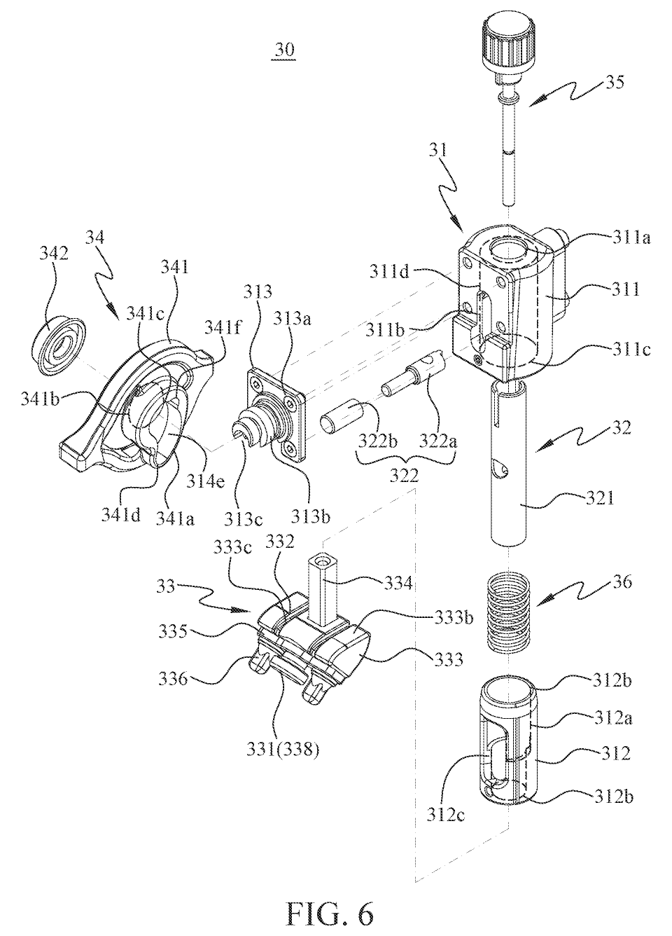

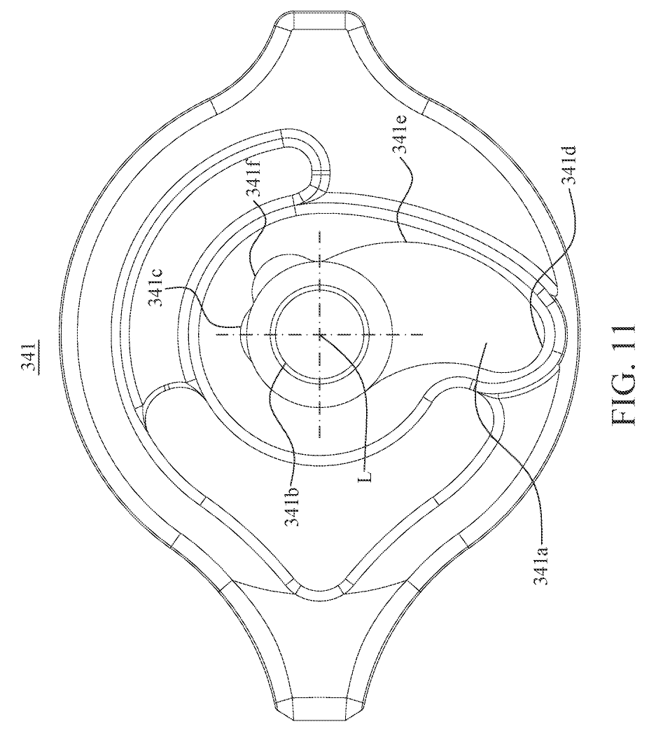

Please refer to FIGS. 6 to 8 and 11. The snare strainer 34 of the adjustment mechanism 30 is pivotally connected to the holding main body 31 of the adjustment mechanism 30, such that the snare strainer 34 can be rotated about a rotation axis L in parallel with the x-axis relative to the holding main body 31. The snare strainer 34 in rotation can bring the movable body 32 to move. As shown, the snare strainer 34 includes a snare strainer tuning plate 341 and a snare strainer cap 342. The snare strainer tuning plate 341 includes a snare strainer rail 341a, which is recessed from one side of the snare strainer tuning plate 341; and a snare strainer pivot hole 341b, which extends along the rotation axis L from the snare strainer rail 341a through the snare strainer tuning plate 341 and is communicable with the snare strainer rail 341a. The snare strainer rail 341a has two opposite ends, one of which is defined as a rail proximal end 341, while the other end is defined as a rail distal end 341d. The snare strainer rail 341a defines a curved rail wall surface 341e, which extends from the rail proximal end 341c toward the rail distal end 341d. A rail recess 341f is formed on the rail wall surface 341e at a position between the rail proximal end 341c and the rail distal end 341d. In the illustrated embodiment, the snare strainer tuning plate 341 is fitted on around the pivot stem 313b of the holding main body 31, such that the pivot stem 313b is extended from the snare strainer rail 314a through the pivot hole 341b, allowing the snare strainer tuning plate 341 to be turnably connected to the pivot stem 313b. Meanwhile, the roller 322b of the linkage rod 322 is extended into the snare strainer rail 341a to contact the rail wall surface 341e of the snare strainer rail 341a, such that a frictional force between the linkage rod 322 and the snare strainer rail 341a can be effectively reduced. The snare strainer cap 342 is locked to the pivot stem 313b to prevent the snare strainer tuning plate 341 from moving out of the pivot rod 313b.

Please refer to FIGS. 6, 7, and 8. The adjustment body 35 of the adjustment mechanism 30 is extended into the movable rod 321 of the movable body 32 via the upper fixed opening 311a of the holding main body 31, such that the adjustment body 35 is rotatable relative to the holding main body 31. Wherein, the adjustment body 35 in the movable rod 321 is screwed to and fitted in the connection guide post 334 of the suspender connection body 33. Whereby, when the adjustment body 35 is rotated relative to the movable body 32, the suspender connection body 33 can be alternatively moved toward or away from the movable body 32. In addition, the return spring 36 of the adjustment mechanism 30 is disposed in the bearing sleeve 312 of the holding main body 31 with an end of the return spring 36 pressed against an inner wall of the fixed holding seat 311 and another end of the return spring 36 pressed against the linkage member 322a of the linkage rod 322, such that the return spring 36 is held between the holding main body 31 and the movable body 32. Wherein, when the return spring 36 is located between the holding main body 31 and the movable body 32, the return spring 36 is elastically deformable. The deformed return spring 36 provides a return force F, which is exerted on the movable body 32. With the aid of the return force F, the roller 322b of the linkage rod 322 of the movable body 32 can be in continuous contact with the rail wall surface 341e of the snare strainer rail 341a.

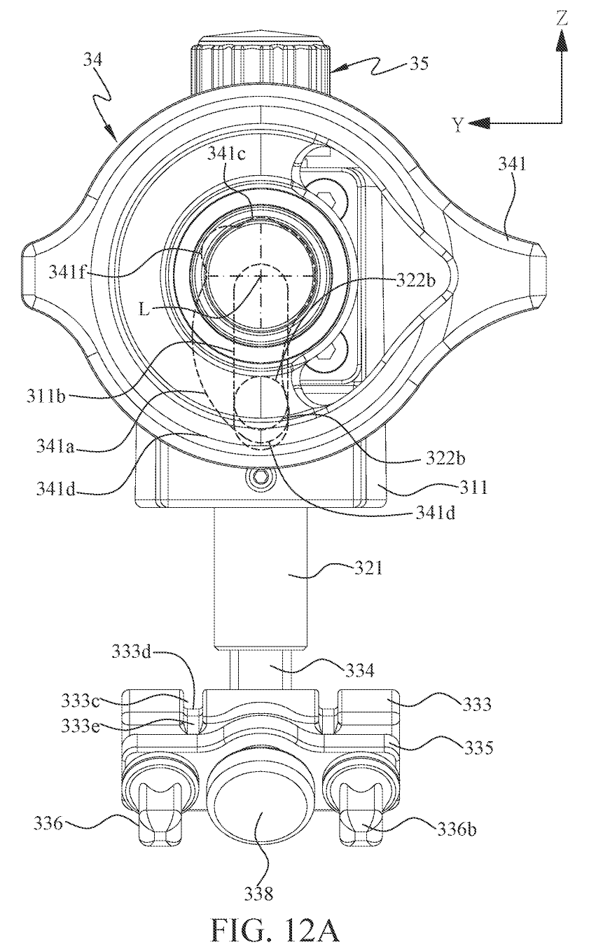

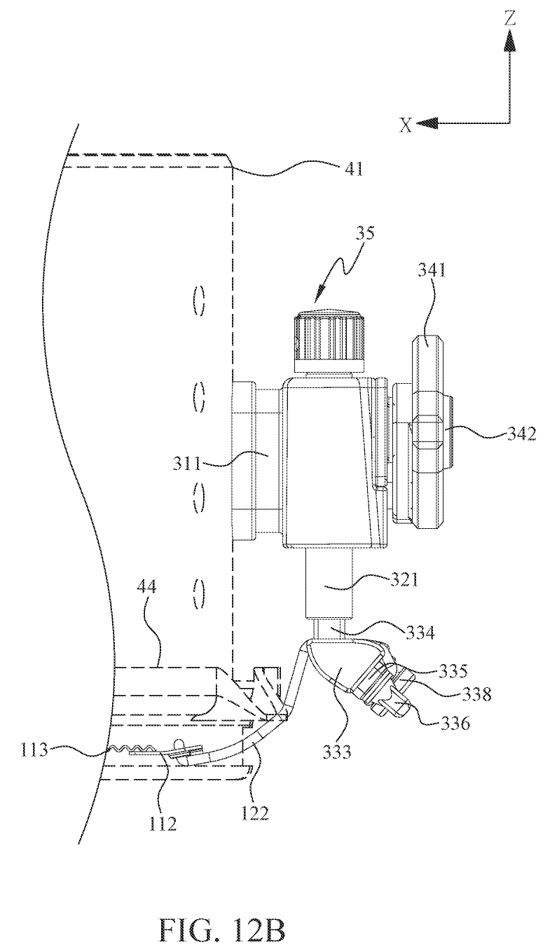

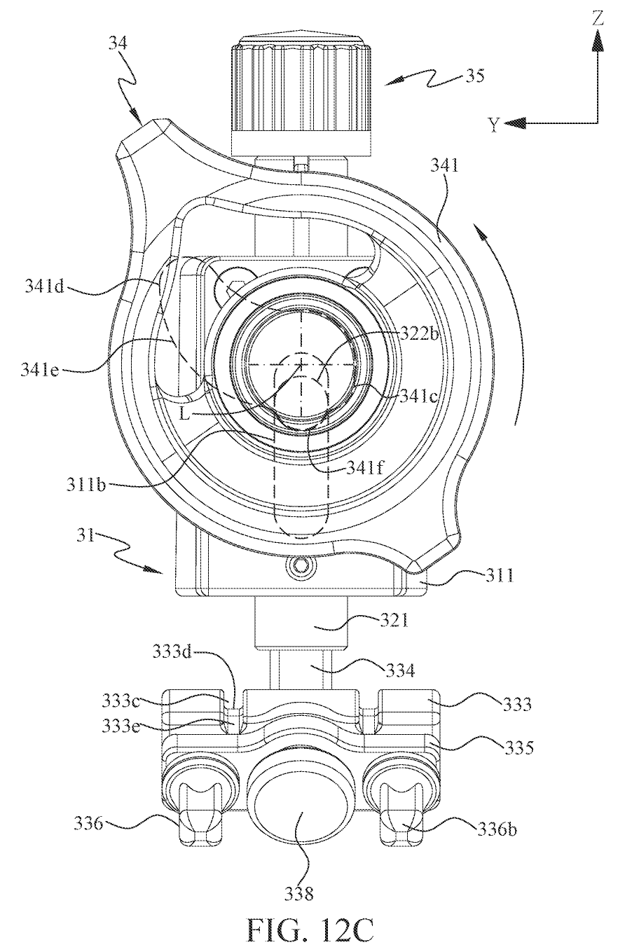

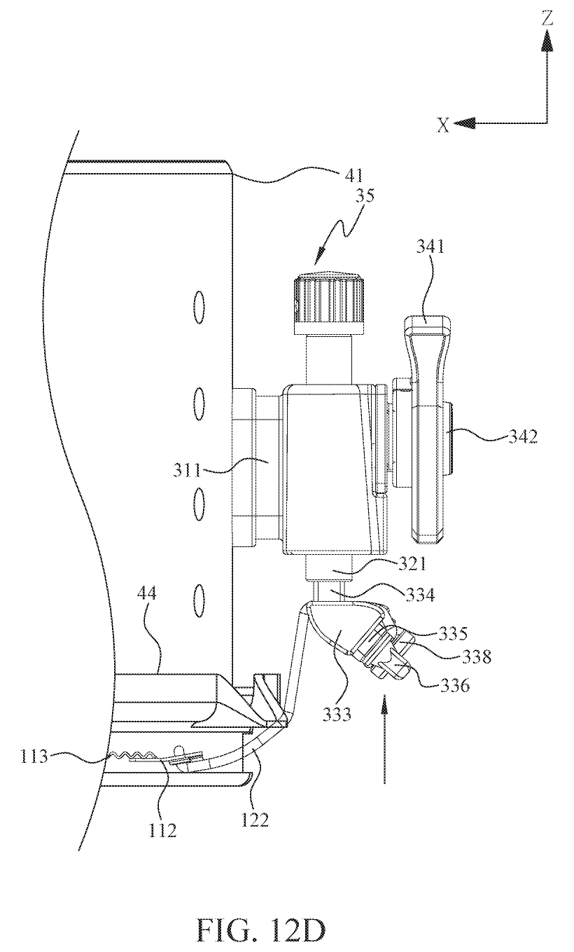

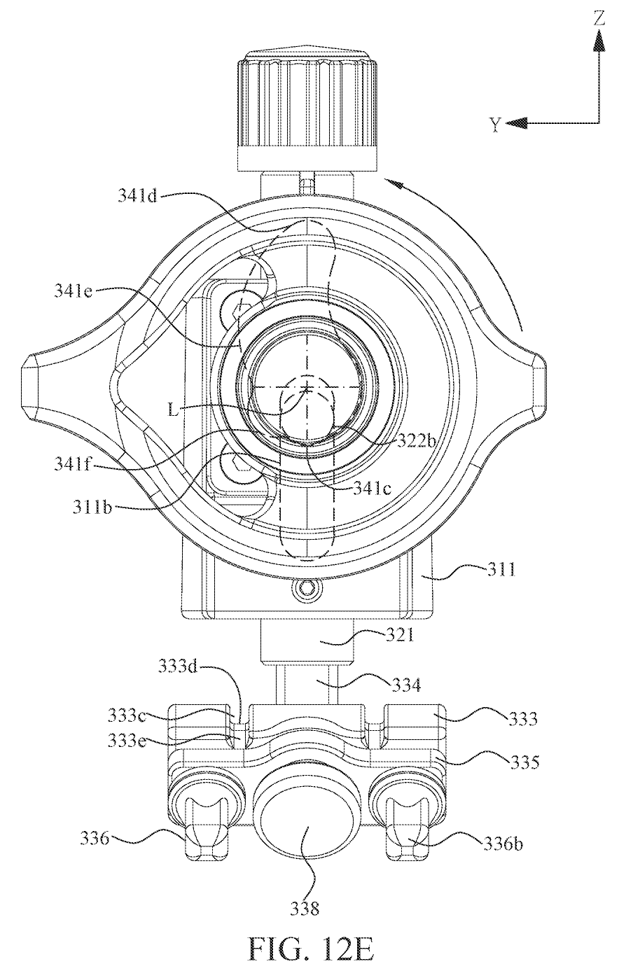

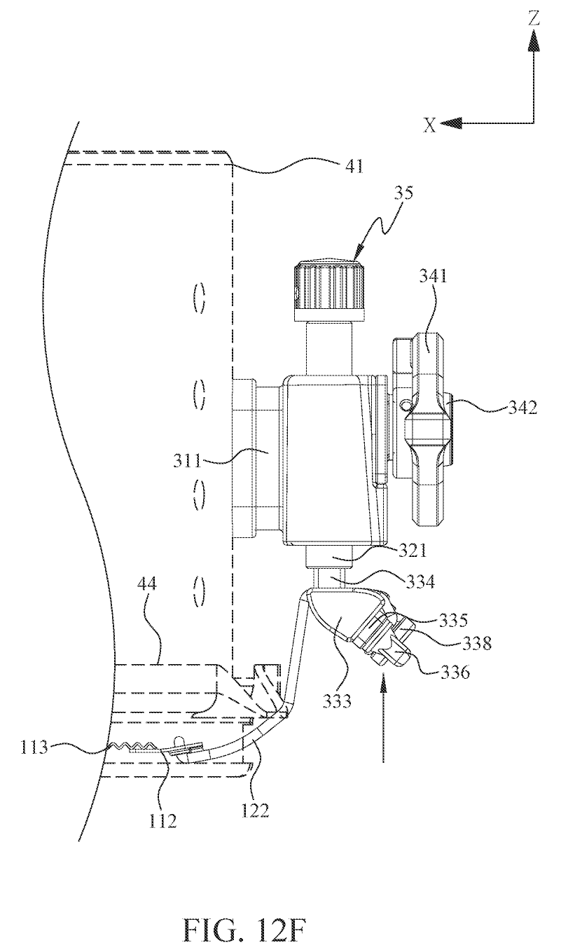

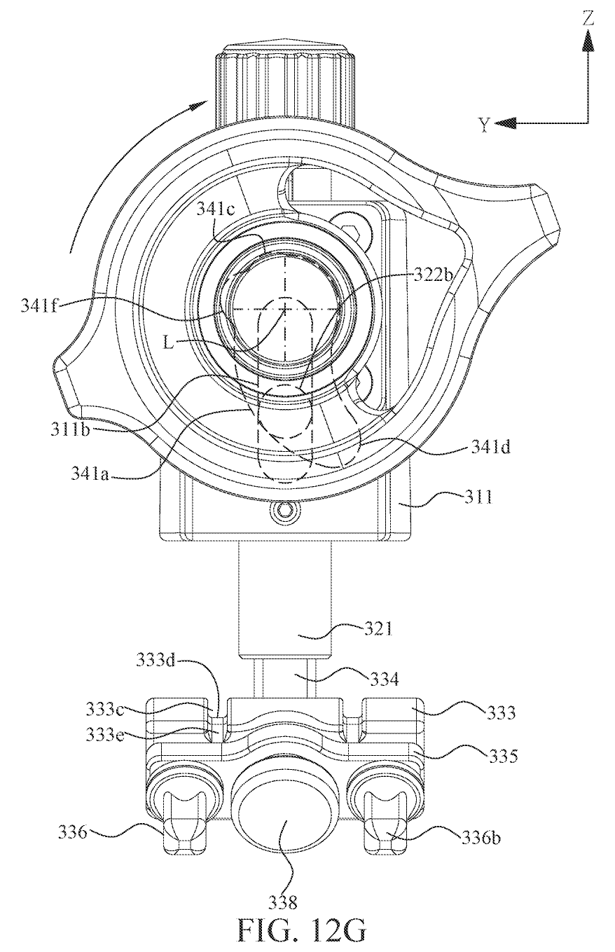

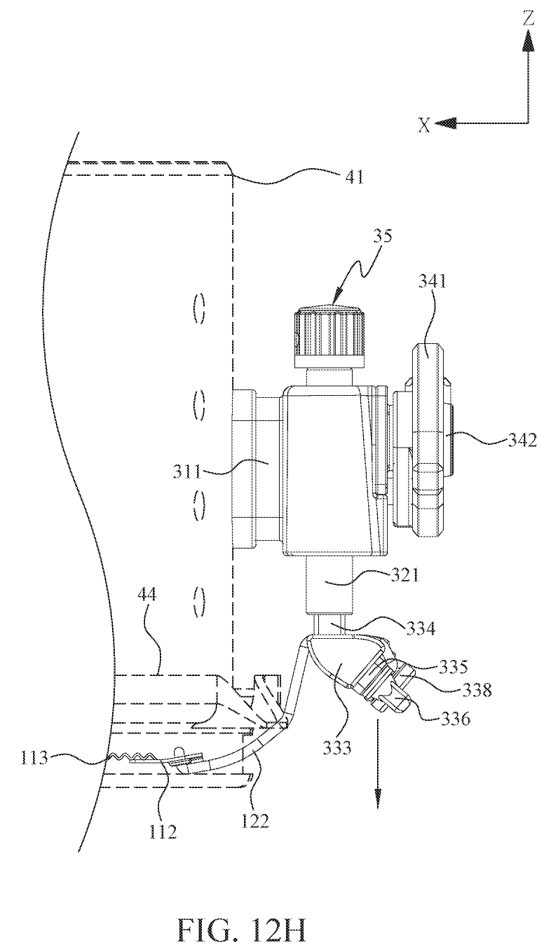

Please refer to FIGS. 12A to 12F, which illustrate an example of adjusting a degree to which the snare wires 113 of the snare mechanism 10 are attached to the snare head 45 of the snare drum 40. First, as shown in FIGS. 12A and 12B, the roller 322b of the linkage rod 322 is pushed by the return force F of the return spring 36 into contact with the rail distal end 341d of the snare strainer rail 341a, such that the linkage rod 322 is moved far away from the snare strainer pivot hole 341b of the snare strainer tuning plate 341, and the linkage rod 322 will be located at a lowest end of the right fixed narrow slot 311b of the fixed holding seat 311. Therefore, the snare wires 113 are in minimal contact with the snare head 45 of the snare drum 40. At this point, when the batter head 43 of the snare drum 40 is played with drumsticks (not shown), vibration of the snare wires 113 can be reduced and sound produced by the snare wires 113 can be correspondingly extended.

As shown in FIGS. 12C and 12D, when the snare strainer tuning plate 341 of the snare strainer 34 is rotated counterclockwise, the roller 322b of the linkage rod 322 is moved in the snare strainer rail 341a along the rail wall surface 341e toward the snare strainer pivot hole 341b of the snare strainer tuning plate 341 gradually. In the process the roller 322b is moving along the rail wall surface 341e, the movable body 32 and the suspender connection body 33 of the adjustment mechanism 30 are moved upward synchronously to tension the snare wires 113 of the snare mechanism 10, so that the snare wires 113 are adjusted to be located closer to the snare head 45 of the snare drum 40 and accordingly, the snare wires 113 can produce an enhanced resonance effect. When the roller 322b is aligned with the rail recess 341f of the snare strainer rail 341a, a part of the roller 322b is stopped into the rail recess 341f, such that the rail recess 341f accommodates a part of the linkage rod 322 therein, and the linkage rod 322 is capable of being moved to the snare strainer rail 341a.

As shown in FIGS. 12E and 12F, when keep turning the snare strainer tuning plate 341 of the snare strainer 34 counterclockwise, the roller 322b of the linkage rod 322 is moved along the rail wall surface 341e of the snare strainer rail 341a from the rail recess 341f toward the rail distal end 341d of the snare strainer rail 341a, such that the linkage rod 322 is gradually moved toward an uppermost point of the right fixed narrow slot 311b of the fixed holding seat 311 and finally moved into the pivot stem groove 313c of the pivot stem 313b. When the roller 322b is moved to the rail distal end 341d, the movable body 32 stops moving relative to the holding main body 31. At this point, the snare wires 113 are set to a maximum value of tension and the degree to which the snare wires 113 are attached to the snare head 45 is maximized. Under this condition, the batter head 43 of the snare drum 40 being played with drumsticks can bring the snare wires 113 to vibrate harder.

As shown in FIGS. 12G and 12H, when the snare strainer tuning plate 341 of the snare strainer 34 is turned clockwise, the roller 322b of the linkage rod 322 is moved along the rail wall surface 341e of the snare strainer rail 341a from the rail proximal end 341c toward the rail distal end 341d of the snare strainer rail 341a to gradually approach a lowest point of the right fixed narrow slot 311b of the fixed holding seat 311, such that the linkage rod 322 is moved away from the pivot stem groove 313c of the pivot stem 313b. When the roller 322b is moved to the rail proximal end 341c, the movable body 32 stops moving relative to the holding main body 31 to thereby reduce the degree to which the snare head 45 is attached to the snare wires 113.

The present invention has been described with a preferred embodiment thereof and it is understood that many changes and modifications in the described embodiment can be carried out without departing from the scope and the spirit of the invention that is intended to be limited only by the appended claims.

What is claimed is:

1. A snare wires adjustment device, comprising:
a snare mechanism including a snare assembly and two suspenders connected to the snare assembly; and
an adjustment mechanism including:
a holding main body for connecting a shell of a snare drum;
a movable body being movably connected to the holding main body, such that the movable body is movable relative to the holding main body;
a suspender connection body being movable synchronously with the movable body and including a suspender hooking section and a contact section; and the suspender hooking section defining a hooking space; and
a snare strainer being capable of driving the movable body to move; and
wherein one of the suspenders being extended from the snare assembly across the contact section to be hooked to the suspender hooking section, such that a part of the suspender is received in the hooking space while another part of the suspender is in contact with the contact section.

2. The snare wires adjustment device as claimed in claim 1, wherein the suspender connection body includes a suspender connection seat and a suspender connection pillar; the suspender connection seat being partially sunken to form two connection recesses for receiving a part of the suspender, such that the part of the suspender received in the connection recesses contacts surfaces of the connection recesses and the connection recesses form the contact section; the suspender connection pillar including a connection neck section located closer to the suspender connection seat and a connection head section located far away from the suspender connection seat; and the hooking space being formed between the connection neck section and the connection head section, such that the suspender connection pillar being formed as the suspender hooking section.

3. The snare wires adjustment device as claimed in claim 2, wherein the suspender connection pillar is located between the two connection recesses, and the suspender connection pillar has an uppermost point below the connection recesses.

4. The snare wires adjustment device as claimed in claim 2, wherein the suspender connection body further includes a connecting plate, a set of plate screws, and a pillar connector; each of the plate screws including a shank portion and a head portion, the shank portion protrudes the connecting plate for fixing on the suspender connection seat, such that the connecting plate is clamped between the head portion and the suspender connection seat; one side of the connecting plate adjacent to the suspender connection seat being sunken to form an accommodating space; the suspender connector including a connection head portion received in the accommodating space and a connection rod portion formed at an end of the connection head portion; and the connection rod portion being located outside the accommodating space and connected to the connection neck section of the suspender connection pillar.

5. The snare wires adjustment device as claimed in claim 4, wherein the suspender connection seat has a first connecting surface in contact with the connecting plate and a second connecting surface forming the connection recesses; each of the connection recess including a first turning corner located adjacent to the first connecting surface and a recess bottom surface located below and spaced from the second connecting surface; wherein when the suspender is located in the hooking space and the connection recesses at the same time, the suspender is in contact with the first turning corner to form a first bending section.

6. The snare wires adjustment device as claimed in claim 5, wherein the connection recesses further include a second turning corner formed on one side of the connection recesses located opposite to the first turning corner, and the suspender being in contact with the second turning corner to form a second bending section that is spaced from the first bending section.

7. The snare wires adjustment device as claimed in claim 1, wherein the movable body includes a movable rod extended through the holding main body and a linkage rod intersecting with the movable rod; the snare strainer including a snare strainer rail recessed from one side of the snare strainer, and the linkage rod being extended into the snare strainer rail; the snare strainer being pivoted to the holding main body to be turnable about a rotation axis relative to the holding main body; the snare strainer rail having a rail proximal end located closer to the rotation axis and a rail distal end located far away from the rotation axis; the snare strainer rail being extended from the rail proximal end toward the rail distal end to form a rail wall surface contactable with the linkage rod; whereby when the snare strainer is rotated relative to the holding main body and the linkage rod can be moved along the rail wall surface to alternatively approach one of the rail proximal end and the rail distal end to be located closer to or far away from the rotation axis, respectively, and allow the movable rod to move relative to the holding main body.

8. The snare wires adjustment device as claimed in claim 7, wherein the snare strainer is provided with a snare strainer pivot hole located adjacent to the rail proximal end and communicable with the snare strainer rail; the holding main body including a pivot stem that is extended into the snare strainer pivot hole and provided at a lower side with a pivot stem groove; whereby when the snare strainer is rotated and the linkage rod is moved toward the rail proximal end of the snare strainer rail, the linkage rod will move into the pivot stem groove; and when the snare strainer is rotated and the linkage rod is moved toward the distal end of the snare strainer rail, the linkage rod will move out of the pivot stem groove.

9. The snare wires adjustment device as claimed in claim 7, wherein the snare strainer rail further includes a rail recess provided between the rail proximal end and the rail distal end for receiving the linkage rod, linkage rod is capable of being moved to the rail recess for stopping temporarily, such that the movable body is stopped in multiple steps by the snare strainer.

10. The snare wires adjustment device as claimed in claim 7, wherein the adjustment mechanism further includes a return spring, the return spring is disposed between the holding main body and the movable body and is elastically deformed to exert a return force on the movable body, such that the linkage rod of the movable body is kept contacting the rail wall surface under the return force.

11. The snare wires adjustment device as claimed in claim 7, wherein the suspender connection body is sleeved in the movable rod of the movable body, and the adjustment mechanism further includes an adjustment body; the adjustment body being extendable through the linkage rod and the movable rod to screw with the suspender connection body, such that the suspender connection body is alternatively movable closer to or far away from the movable body when the adjustment body is rotated relative to the movable body.

12. The snare wires adjustment device as claimed in claim 7, wherein the linkage rod includes a linkage member connected to the movable rod and a roller made of a non-metal material; the roller being mounted to an end of the linkage member and being in contact with the rail wall surface to reduce a frictional force between the linkage rod and the snare strainer rail.
